(19) United States
(12) Patent Application Publication
(10) Pub. No.: US 2006/0151119 A1
(43) Pub. Date: Jul. 13, 2006

(54) Adhesive tape dispenser

(76) Inventors: Wolfgang Klauck, Meerbusch (DE); Heinrich W. Steinel, Bad Woerishofen (DE); Werner Moosmann, Tennenbronn (DE)

Correspondence Address: HENKEL CORPORATION, THE TRIAD, SUITE 200, 2200 RENAISSANCE BLVD., GULPH MILLS, PA, 19406, US

(21) Appl. No.: 11/372,855

(22) Filed: Mar. 10, 2006

Related U.S. Application Data
(63) Continuation of application No. PCT/EP04/10004, filed on Sep. 8, 2004.

(30) Foreign Application Priority Data
Sep. 10, 2003 (DE) 103 42 085.1

(51) Int. Cl. B65H 35/00; B44C 7/06

(52) U.S. Cl. 156/577

(57) ABSTRACT

An adhesive tape dispenser with a holder for a coiled adhesive tape rotatable about an axis and with an outer part connected with the holder and disposed radially from the tape roll. The outer part is suitable for detaching or fixing, or for detaching and fixing, the free end of the tape roll and being movably connected with the holder or with a bearing core of the holder, on which an adhesive tape roll is received and rotatable.

### CROSS REFERENCE TO RELATED APPLICATIONS

This application is a continuation under 35 U.S.C. § 365(c) and 35 U.S.C. § 120 of international application PCT/EP2004/010004, filed on Sep. 8, 2004. This application also claims priority under 35 U.S.C. § 119 of DE 103 42 085.1, filed on Sep. 10, 2003, which is incorporated herein by reference in its entirety.

### BACKGROUND OF THE INVENTION

The present invention relates to an adhesive tape dispenser with a holder for reception of a coiled adhesive tape roll to be rotatable about an axis and with an outer part connected with the holder and disposed radially outwardly of an insertable or inserted adhesive tape roll, the outer part being suitable for detaching or fixing, or for detaching and fixing, the free end of an inserted adhesive tape roll and being movably connected with the holder or with a bearing core, on which an adhesive tape roll can be is received to be rotatable, of the holder.

Adhesive tape dispensers or adhesive tape unrolling devices are generally known in various forms. They serve the purpose of receiving adhesive tapes, which are coiled to form adhesive tape rolls, and to facilitate unrolling of the adhesive tapes. Thus, for example, adhesive tape dispensers are known in which an adhesive tape roll is entirely or partly received in a housing and mounted therein to be rotatable about an axis for unfeeling a piece of adhesive tape. For that purpose the housing frequently has projections, which are oriented around the axis of rotation, or a bearing core on which is mounted a core reel usually consisting of plastics material and with the adhesive tape roll coiled thereon. In addition, the housing has a detaching device for detaching a piece of adhesive tape withdrawn from the adhesive tape roll and a tape holding part for fixing and easy picking up again of the free end of the adhesive tape roll. In the case of use of adhesive tape detachable by hand the adhesive tape dispenser can also be constructed without a separating device. The tape holding part serves, after detaching of a withdrawn piece of adhesive tape, the purpose of fixing the new free end of the adhesive tape roll, particularly by light adhesion, at a position where it can be easily grasped by the user and preventing the end from falling back onto the adhesive tape roll, where the free adhesive tape end can often be difficult to recognise and can be troublesome to pull free again.

Adhesive tape dispensers of that kind with a rigid housing oblige—regardless of the diameter of the adhesive tape roll still present—a relatively large constructional size oriented towards the diameter of the largest adhesive tape roll able to be received.

In addition, special forms of embodiment of adhesive tape dispensers are known in which the tape holding part is movably connected with the holder of the adhesive tape dispenser. Thus, an adhesive tape dispenser of that kind, of the form stated in the introduction, is known from, for example, WO 94/12414 A1. In this connection an outer grip member is movably connected with an inner holder by way of two webs. The size of the adhesive tape dispenser can thereby be constantly adapted to the size of the adhesive tape roll still present.

However, it is disadvantageous in this connection that the inner radius of the outer grip member cannot, with decreasing diameter of the adhesive tape roll, be adapted to the reducing radius of the adhesive tape roll, so that a defined positioning of the grip member relative to the adhesive tape roll is not possible. Moreover, the tape holding part is so arranged in this connection that the free end of the adhesive tape roll is held with adhesive surface facing outwardly, whereby the adhesive capability at the end section of the adhesive tape, particularly in the event of a longer period of non-use or in the event of unintended contact with other objects, is substantially impaired.

Beyond that, notwithstanding the overall relatively simple format there is still a construction which due to the two obligatory pivot connections of the webs with, on the one hand, the grip member and, on the other hand, the holder makes further simplification appear desirable.

An adhesive tape dispenser of the kind stated in the introduction is, moreover, also known from EP 0 341 172 A1. In this connection a yoke is pivotably mounted on the holder of the adhesive tape dispenser, two support straps as holding part for the free end of the adhesive tape roll being disposed at the outer end of the yoke.

The yoke can freely pivot back and forth here as well, insofar as it is not fixed by the free end of the adhesive tape. A defined positioning of the yoke relative to the holder of the adhesive tape dispenser is therefore not possible without an inserted adhesive tape roll, so that the yoke can freely swing to and fro. Moreover, in this connection a rotary pivot connection between the yoke and the holder is also required and the avoidance of such a connection in the sense of simplification of the construction and an associated reduction in production costs would be desirable.

The object of the present invention is therefore to create an easily manageable adhesive tape dispenser of the kind stated in the introduction, which always ensures a defined positioning—demanding the least possible space—of the relatively movable components and which by virtue of a simplified construction is economic to manufacture.

### SUMMARY OF THE INVENTION

According to the invention this object is fulfilled by an adhesive tape dispenser (1) with a holder (2) for reception of a coiled adhesive tape roll to be rotatable about an axis (5) and with an outer part (4) connected with the holder (2) and disposed radially outwardly of an inserted or insertable adhesive tape roll, the outer part (4) being suitable for fixing and/or detaching the free end of an inserted adhesive tape roll and being movably connected with the holder (2), characterised in that the adhesive tape dispenser (1) comprises at least one resilient means (3) by which the outer part (4) is loaded in a direction in which the spacing thereof from the axis (5) reduces.

The invention is further embodied by an adhesive tape dispenser (1) with a holder (2) for reception of a wound adhesive tape coil (23) to be rotatable about an axis (5) and with an outer part (4) connected with the holder (2) and disposed in a region lying radially outwardly of an insertable adhesive tape roll (23), the outer part being suitable for fixing and/or detaching the free end (33) of an insertable adhesive tape roll (23), wherein the holder (2) comprises a bearing core (26) on which an adhesive tape roll (23) is receivable to be rotatable and the outer part (4) being movably connected with the bearing core (26) of the holder (2), wherein the adhesive tape dispenser (1) comprises at least one resilient means (3, 3a) by which the outer part (4) and/or the bearing core (26) is loaded in a direction in which the spacing between the outer part (4) and the bearing core (26) reduces, wherein the bearing core (26) is eccentrically pivotable about a pivot axis (27) and is mounted between the side walls (6) of the holder (2) to be loaded by the resilient means (3a) and wherein the bearing core (26) is formed by a hollow cylinder and the resilient means (3a) is arranged in the cavity (38) of the cylinder, the outer part (4) being fixedly connected with side walls (6) of the holder (2).

The adhesive tape dispenser comprises at least one resilient means by which the outer part and/or the bearing core is loaded in a direction in which the spacing between the outer part on the one hand and the axis or the bearing core on the other hand reduces.

In this connection the outer part is subjected to a resilient loading which has at least a part component with a direction towards the axis and/or the bearing core is subjected to a resilient loading which has at least a part component with a direction towards the outer part.

The principal advantage consists in that the relatively movable components of the adhesive tape dispenser constantly adopt a defined position relative to one another, wherein the smallest possible and most space-saving positioning is always taken up at the same time. This optimum positioning of the components is, in advantageous manner, achieved not only with, but also without, an inserted adhesive tape roll. If in the present invention mention is made of an inserted adhesive tape roll, then the statements made always refer not only to an adhesive tape dispenser with a previously inserted adhesive tape roll, but also to an adhesive tape dispenser in which an adhesive tape roll is inserted by a user only subsequently.

It is particularly advantageous if the outer part can be brought by the resilient means resiliently into contact with the outer circumferential surface of an inserted adhesive tape roll. The smallest possible external dimension of the adhesive tape dispenser is thereby achieved even in the case of an inserted adhesive tape roll and independently of the instantaneous diameter thereof. Moreover, the outer part is always disposed at the smallest possible spacing from the free end of the adhesive tape, so that here only a very short region of residual adhesive tape roll has to be withdrawn if the outer part is used as tape holding part for holding the free end of the adhesive tape roll.

A particularly rigid form of construction of the adhesive tape dispenser according to the invention can be achieved by provision of two resilient means arranged and effective at the two end faces of the outer part or at the two end faces of an inserted adhesive tape roll. If mention is made in the following of resilient means, then the statements made can obviously also apply to an embodiment with two laterally arranged resilient means.

Any resilient element, particularly torsion springs, spiral springs, leg springs and rubber-elastic spring means can be used as resilient means. It is particularly advantageous if the resilient means comprises a compression spring pressing the outer part from outside against an inserted adhesive tape roll. However, in the alternative it is just as possible to realise the resilient means by a tension spring drawing the outer part from the inside against the outer circumferential surface of the adhesive tape roll.

According to a particularly preferred form of embodiment of the invention it is proposed to form the resilient means by a bent spring arm connecting the holder with the outer part, the bend of the spring arm being resiliently reducible. Through reduction in the degree of bending or through enlargement of the radius of bending of the spring arm the outer part is displaced outwardly from where it is loaded back in inward direction by the resilience of the spring arms.

In this connection it is particularly advantageous if the spring arm is bent substantially parabolically or in U-shape, wherein one end region of the spring arm extends out at least approximately tangentially from a region of the holder disposed between the axis and an inserted adhesive tape roll and wherein the other end region of the spring arm ends at least approximately tangentially on the diameter of the outer circumference of an inserted adhesive tape roll. The spring arm in that case is advantageously disposed axially adjacent to the inserted adhesive tape roll. A particularly good resilience of the spring arm can be achieved by the parabolic or U-shaped construction.

According to a further particularly preferred form of embodiment of the invention a respective spring arm bent parabolically or in U-shape is arranged on each of the two sides axially adjacent to an inserted adhesive tape roll, wherein the two spring arms are connected together at the end regions thereof on the one hand by the holder of the adhesive tape dispenser and on the other hand by the outer part. A form of embodiment which is particularly simple in terms of construction and with a small number of parts and very low weight thereby results.

In order to increase the rigidity of the adhesive tape dispenser it is proposed to connect together the two spring arms in an intermediate region by an additional connecting web disposed radially outside an inserted adhesive tape roll. The connecting web is preferably arranged to project radially outwardly, wherein the intermediate region is preferably disposed between the outer part and the centre of the spring arms. In the case of an arrangement of that kind the dispenser can, when the axis is oriented horizontally, be placed by the outer part and the connecting web on a support in a particularly manner.

Moreover, it is particularly advantageous if the two spring arms each have at the end region thereof connected with the outer part a respective inwardly projecting projection, which can be placed as guide means axially against the end face of an inserted adhesive tape roll. A precise axial positioning of the outer part relative to an inserted adhesive tape roll can thereby be secured.

So that the free end of an inserted adhesive tape roll can be fixed in a position in which it can be easily grasped by the user and an unintended adhesion to the outer winding of the adhesive tape roll can be prevented it is furthermore proposed in accordance with the invention to provide the outer part with a tape holding region having an outwardly facing roughened and/or ridged surface to which the free end of an adhesive tape winding is able to adhere so as to be readily detachable. This surface can also be provided by application of other materials as an adhesion-reducing coating. Moreover, an appropriate chemical treatment is possible for achieving an anti-adhesive surface.

In addition, it is of advantage to provide a detaching device at the outer part for easy detachability of a piece of tape which is withdrawn from the adhesive tape roll, but which is not to be detached by hand alone. The detaching device can comprise, for example, sharp edges, toothed strips or one or more knives which are either directly formed in integral manner or which can be subsequently mounted and are of other different materials.

Alternatively or additionally thereto it is proposed that the outer part of the adhesive tape dispenser has a tear-off edge which is radiussed about an axis extending parallel to the axis of rotation of the adhesive tape roll. A radiussed tear-off edge in the case of adhesive tape able to be torn off by hand is particularly advantageous, particularly with side edges formed to be grooved, serrated or corrugated, so that injuries due to pointed or sharp-edged regions of a detaching device of the adhesive tape dispenser can be avoided. Advantageously the form of embodiment of the tear-off edge is matched to the tear characteristics of the adhesive tape.

Moreover, it is particularly advantageous if the holder has a grip recess on at least one of its two outwardly disposed side surfaces or side walls. The adhesive tape dispenser can thus be held particularly easily in the hand.

According to a further particularly preferred form of embodiment of the invention it is provided that the adhesive tape dispenser has means acting in mechanically positively locking and/or frictionally locking manner for prevention or hindrance of return rotational movement opposite to a rotational movement in the direction of unrolling of an inserting or insertable adhesive tape roll. Rotation of the adhesive tape roll in the incorrect direction is thereby avoided, so that the free end of the adhesive tape roll can always be easily gripped by the user.

In that case it is especially advantageous if the holder comprises means, particularly resilient means, co-operating—as reverse rotation brake or reverse rotation blocker—with the core roll of an adhesive tape roll.

Moreover, it is particularly advantageous if there is arranged at the holder at one or both sides at least one spring tongue which is oriented in circumferential direction of a core reel to be received, or a received core reel, of an adhesive tape roll and the free end of which faces in the desired direction of unrolling of the adhesive tape roll and resiliently protrudes axially inwardly in order to resiliently engage in recesses of the core reel provided at the end face of the core reel. When a piece of adhesive tape is pulled off, the tongues are resiliently pressed outwardly by the edge regions of the recesses of the core reel so that a rotational movement of the adhesive tape roll in the desired direction of unrolling is possible, where against the end regions of the tongues engaging inwardly in the recesses of the core reel block movement in the opposite direction of rotation. The recesses of the core reel at the end faces can in that case be formed in particularly simple manner by the spacings between spokes of the core reel.

If the adhesive tape dispenser has one or two bent spring arms it is in addition particularly advantageous if at least one spring arm in an axially and/or radially resilient region, which bears or can bear against a toothing of the core roll of an inserted or insertable adhesive tape roll or directly against a toothed end face of an inserted or insertable adhesive tape roll, has a projection—particularly a lug protruding in the form of a wedge—for engagement in the corresponding toothing. The resilient region of the spring arm can in that case be formed by its intrinsic elasticity and/or by an additionally mounted spring element. Insofar as the lug is engaged in an adhesive tape laterally provided with recesses a return rotational movement is at least made substantially difficult. In the case of engagement of the lug or other resilient spring means in a toothing, which can be arranged laterally or at the inner side at the core reel, return rotational movement of the adhesive tape roll can also be completely prevented.

A particularly simple and economic production of the adhesive tape dispenser can be achieved if it is made completely or at least predominantly of plastics material. Advantageously the entire dispenser can in that case be of integral construction, wherein the two side regions of the holder are connected together by way of the resilient means and the outer part and can be resiliently bent outwardly for reception of an adhesive tape roll. Alternatively, the adhesive tape dispenser can also be of multi-part construction, particularly constructed in two side parts corresponding with one another, which after reception of an adhesive tape roll are secured to one another. The plastics material is preferably formed to be transparent.

In this connection the adhesive tape dispenser can in principle be made from all kinds of plastics material, for example from the group of thermoplastic or thermosetting plastics, wherein preferably use is made of plastics which can be processed by injection moulding. Moreover, plastics materials are preferred which enable permanently resilient characteristics of the resilient means or the spring arms, polycarbonate, in particular, being used. Other parts of the adhesive tape dispenser can, however, also be made from other materials.

According to an alternative form of embodiment of the invention a bearing core is mounted between the side walls of the holder to be eccentrically pivotable about an eccentric pivot axis and is loaded by the resilient means. By virtue of the eccentric mounting the spacing of the bearing core from the outer part can be varied by pivoting the bearing core. In that case the bearing core is preferably formed by an at least partly hollow cylinder, the resilient means being arranged in the cavity of the cylinder. The diameter of the cylinder is adapted to the internal diameter of adhesive tape rolls to be received or to the internal diameter of corresponding core reels on which an adhesive tape roll is wound.

In that case it is in addition especially advantageous if the outer part is fixedly connected with the side walls of the holder particularly by way of at least one rigid connecting arm. A very rigid form of embodiment thereby results. The mobility, in accordance with the invention, of the adhesive tape dispenser is in that case ensured by the pivotable mounting of the bearing core.

Moreover, it is then particularly advantageous if the holder comprises abutment means to limit the range of pivotation of the bearing core. These abutment means can preferably comprise at least one projection or pin which protrudes axially inwardly from at least one side wall of the holder and which engages in an arcuate recess or opening in an end face of the bearing core.

In that case it is in addition particularly advantageous if the resilient means comprise a leg spring which is pivotably mounted by means of the eye thereof on the pivot axle of the bearing core and which is supported by one leg against the inner wall of the cavity of the bearing core and by the other leg against the projection, which protrudes as abutment means into the cavity via the opening in the end wall of the bearing core. A particularly compact form of construction thereby results.

A particularly preferred form of embodiment of the invention proposes that the adhesive tape dispenser is constructed as a disposable dispenser with a previously inserted adhesive tape roll. The side edges of the adhesive tape roll can thereby preferably be formed to be grooved, serrated or corrugated in order to enable easy detachment of an adhesive tape section by hand even without a detaching device, so that injuries due to pointed or sharp-edged regions of the adhesive tape dispenser can be avoided.

Alternatively thereto, however, there is also the possibility of constructing the adhesive tape dispenser as a repeat-use reusable dispenser or as a user-fill device into which the user can insert a desired adhesive tape roll or, as required, a new adhesive tape roll.

In general, the adhesive tape dispenser can be fitted with all types and kinds of adhesive tapes. Thus, for example, adhesive tapes, which are adhesive at one side or at two sides, with withdrawable protective layers, can also be used.

### BRIEF DESCRIPTION OF THE DRAWINGS

Further advantages and features of the invention are evident from the following description and the examples of embodiment illustrated in the drawings, in which:

FIG. 1 shows a three-dimensional view of a first form of embodiment of an adhesive tape dispenser according to the invention;

FIG. 2 shows a three-dimensional view of a second form of embodiment of an adhesive tape dispenser according to the invention;

FIG. 3 shows a two-dimensional side view of the variant of embodiment of FIG. 2;

FIG. 4 shows a two-dimensional side view of a third form of embodiment of an adhesive tape dispenser according to the invention;

FIG. 5 shows a three-dimensional view of a fourth form of embodiment of an adhesive tape dispenser according to the invention, with inserted adhesive tape roll;

FIG. 6 shows a cross-section through the form of embodiment of FIG. 5 in a first positioning of the bearing core, wherein the adhesive tape roll is omitted; and

FIG. 7 shows a cross-section through the form of embodiment of FIG. 5 in a second positioning of the bearing core, wherein the adhesive tape roll is similarly omitted.

### DETAILED DESCRIPTION OF THE INVENTION

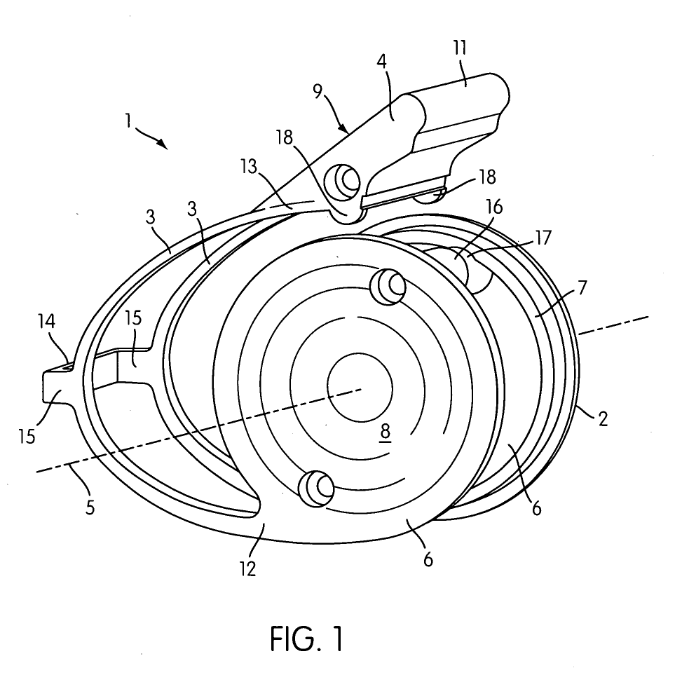

The adhesive tape dispensers 1 shown in FIGS. 1 to 4 are in each instance illustrated without an adhesive tape roll. They are made entirely of plastic, the entire adhesive tape dispenser 1 being injection-moulded in one piece so that a particularly economic capability of manufacture is ensured.

The adhesive tape dispenser 1 has a holder 2 and an outer part 4 connected therewith by way of two laterally arranged spring arms 3. The holder 2 serves for rotatable reception of an adhesive tape roll, which is usually coiled on a core reel. When a piece of adhesive tape is pulled off the free end of the adhesive tape roll the adhesive tape roll rotates about the axis 5. The holder for this purpose comprises two side walls 6 which are opposite one another at a spacing corresponding with the width of an adhesive tape roll to be received and at which axially inwardly pointing annular projections 7, which are concentric with respect to the axis 5 and can engage in the central bore of a core reel, are provided at the inner side for rotational mounting of an adhesive tape roll. So that the adhesive tape dispenser 1 can be held in the hand particularly easily by the user a respective central grip recess 8 is formed in each of the two side walls 6 at the outer side.

The outer part 4 is arranged radially outwardly of an insertable adhesive tape roll and serves the purpose of fixing the free end of an inserted adhesive tape roll so that the user can easily again grasp the free end of the adhesive tape roll. For this purpose the outer part has a tape holding region provided with an outwardly facing roughened surface 9 to which the free end of an adhesive tape roll can adhere to be readily detachable.

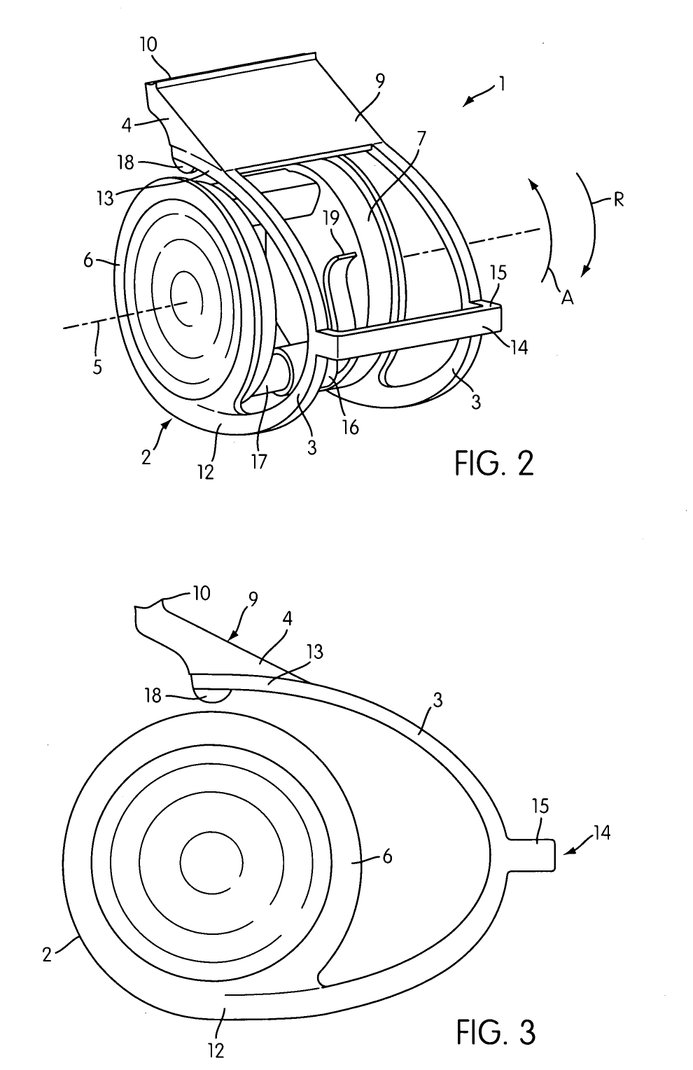

In the case of the variant of embodiment illustrated in FIGS. 2 and 3 the outer part additionally serves the purpose of being able to easily detach an adhesive tape strip pulled off the adhesive tape roll by the user. For this purpose a tear-off edge 10, which can be provided with a small grooving or toothing, can be provided at the outer part as detaching device. By contrast the form of embodiment shown in FIG. 1 is provided for use with adhesive tape provided at the edge with a serration or grooving and therefore able to be easily torn off by hand. Accordingly a sharp-edged construction of the outer part 4 is not required here and the outer region thereof is formed with an injury-excluding radiussed edge 11.

According to the invention the adhesive tape dispenser 1 comprises at least one resilient means by which the outer part 4 is loaded inwardly in such a manner that the spacing thereof from the axis 5 is smaller. When an adhesive tape roll is inserted, the result is that the outer part 4 is at all times resiliently pressed into contact with the outer circumferential surface of the inserted adhesive tape roll.

In the case of the forms of embodiment illustrated in the figures the resilient means are formed by the two elastically resilient spring arms 3 by way of which the outer part 4 is at the same time movably connected with the holder 2 without necessitating an articulated connection for that purpose. The two parabolically bent spring arms 3 each extend in the plane of a respective side wall 6 of the holder 2 and are thus axially offset laterally adjacent to an adhesive tape roll to be inserted. The inner end 12 of the spring arm 13 tangentially opens into the outer circumference of the circular side walls 2. The outer end 13 of the spring arm 3 is, in the rest state, disposed in each instance at a small spacing radially outwardly of the outer circumference of the side walls 6 in a region substantially diametrically opposite the inner end 12. Through resilient bending the spring arms 3 are, in the case of a reduction of the bending radius thereof, biased and the outer ends 13 thereof spring outwardly in such a manner that the outer part 4 arranged therebetween is resiliently pressed back onto the outer circumferential surface of an inserted adhesive tape roll.

The two spring arms 3 are integrally connected together at the outer ends 13 thereof by the outer part 4. In addition, the two spring arms 3 are also connected together in a centre intermediate region by a connecting web 14 in order to increase the rigidity of the adhesive tape dispenser 1. The connecting web 14 is in that case moulded integrally with the two spring arms 3 respectively by way of two radially outwardly projecting radial webs 15 so that the web 14 is disposed radially outwardly of an insertable adhesive tape roll.

Whereas the outer ends 13 and the centre intermediate region of the two spring arms 3 are thus fixedly interconnected, the two side walls 6 of the holder 2 are not directly moulded to one another, but are connected together merely by way of the spring arms 3 and the connecting web 14 as well as the outer part 4. The two side walls 6 of the holder 2 can therefore be resiliently bent outwardly in axial direction for reception of an adhesive tape roll. After insertion of an adhesive tape roll the side walls 6 spring back inwardly and are fastened to one another by way of the connecting webs provided at the inner side. These connecting webs consist on the one hand of sleeves 16 and on the other hand of pins 17 plugged into the sleeves 16 to provide mechanically positive coupling. If the adhesive tape dispenser 1 is a non-refillable disposable device the pins 17 are non-detachably secured to the sleeves 16 by material coupling. If, thereagainst, the adhesive tape dispenser 1 is a repeat-use and thus refillable multi-use device the pins 17 can be detachably fastened to the sleeves 16 by friction couple or by releasable fastening means, particularly by screws.

A respective radially inwardly projecting projection 18 is integrally formed at the outer end 13 of each of the two spring arms 3 and comes into contact, as axial guide means, with the end face of an insertable adhesive tape roll.

In the case of the form of embodiment illustrated in FIG. 2 two detent lugs 19 elastic in radial direction and resilient outwardly are integrally formed respectively at side walls 6 of the holder 2 at the inner side as return rotation securing means, acting in mechanically positively locking and frictionally locking manner, for preventing rotation opposite to the unrolling direction A of an insertable adhesive tape roll. The free ends of the two detent lugs 19 protrude at an angle outwardly within the inner end edges of the annular projections 7 so as to engage in radially inwardly facing recesses of the core reel of an adhesive tape roll to be inserted. The free ends of the detent lugs 19 face, by their inclined arrangement, in the desired unrolling direction A of the adhesive tape roll. On withdrawal of a piece of adhesive tape the free ends of the detent lugs 19 are resiliently pressed radially inwardly by the edges of the recesses of the core reel so that a rotational movement of the adhesive tape roll in the desired unrolling direction A is made possible. Thereagainst, rotation in the opposite rotational direction R is blocked by the ends of the detent lugs 19 engaging at an angle outwardly in the recesses of the core reel. The radially inwardly facing recesses of the core reel of an adhesive tape roll to be inserted can in that case be formed by spacings between the radially inwardly disposed ends of spokes of the core reel.

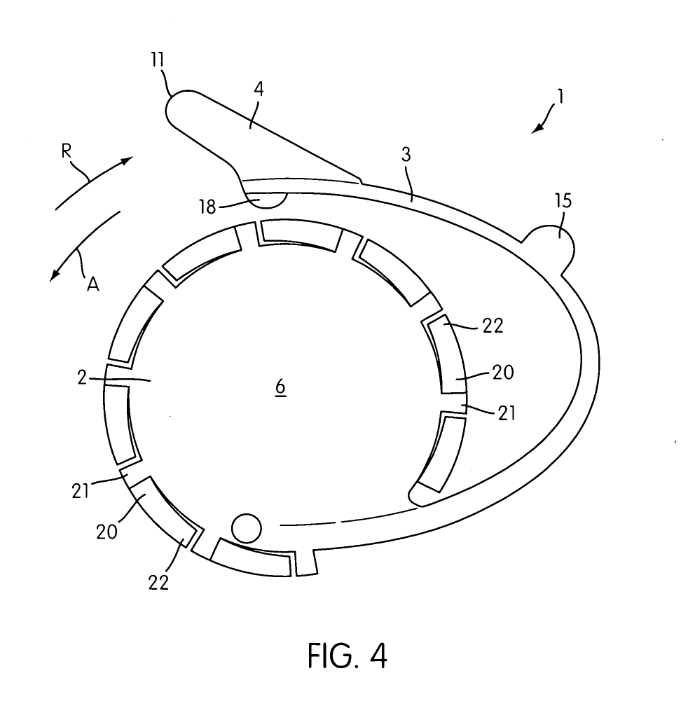

In the case of the form of embodiment illustrated in FIG. 4 several spring tongues 20 extending in circumferential direction from radially outwardly directed webs 21 are provided as return rotation securing means acting in mechanically positively locking and frictionally locking manner. The webs 21 are respectively integrally formed at one of the two side walls 6 of the holder 2. The spring tongues 20 are in that case arranged at the two side walls 6 to be distributed over the outer circumference of the holder 2 in such a manner that their free ends 22 face in the desired unrolling direction A of the adhesive tape roll. These free ends 22 project axially inwardly in resilient manner so as to resiliently engage in recesses of the core reel provided at the end face of the core reel. When a piece of adhesive tape is pulled off, the spring tongues 20 are resiliently pressed outwardly by the edge regions of the recesses of the core reel so that rotational movement of the adhesive tape roll is possible only in the desired unrolling direction A. Rotational movement in the opposite direction R is blocked by the end regions 22 of the spring tongues 20 engaging inwardly in the recesses of the core reel.

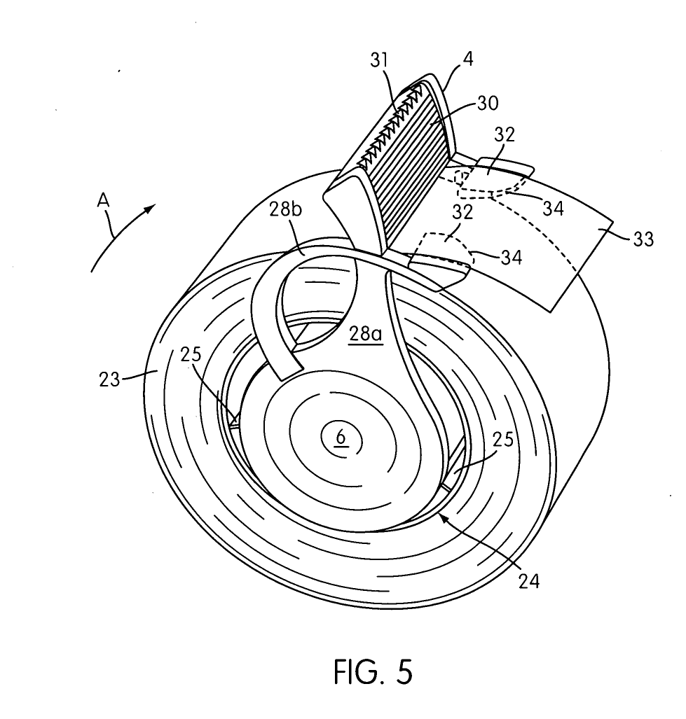

In the case of the variant of embodiment, which is illustrated in FIGS. 5 to 7, of an adhesive tape dispenser 1 according to the invention there is illustrated in FIG. 5 merely an inserted adhesive tape roll 23 coiled up on a core reel 24. The core reel 24 here consists of two concentric sleeves interconnected by way of a plurality of radial ribs 25. They can, however, also consist of merely a single sleeve.

The inner sleeve of the core reel 24 is rotatably mounted with a small amount of play on a bearing core 26 which is of hollow cylindrical form and comprises the holder 2. The central axis of symmetry of the bearing core 26 in that case forms the axis 5 of rotation of the adhesive tape roll 23. The bearing core 26 is thus mounted between the two side walls 6 of the holder 2 to be eccentrically pivotable about an eccentric pivot axis 27, whereby its positioning relative to the side walls 6 of the holder 2 as well as the spacing of the bearing core 26 from the outer part 4 can change.

The outer part 4 is in that case fixedly connected, at both end faces, with the side walls 6 of the holder 2 respectively by way of two rigid connecting arms 28a and 28b. The connecting arms 28a and 28b extend with different degrees of bending and are interconnected in the region of the outer part 4 at an intersection 29, the connecting arms 28a and 28b each being prolonged outside the intersection 29 in a respective extension. A continuous connecting region 30 with an integrally formed toothed strip 31 for detaching a piece of tape pulled off the adhesive tape roll 23 extends between the extensions of the two connecting arms 28a. A tape holding region 32 with a roughened surface 9 extends inwardly from each of the extensions of the two connecting arms 28b, wherein a gap for initial feeding through of the free adhesive tape end 32 is left between the two tape holding regions 32. In order to facilitate the initial feeding through of the adhesive strip end 33 the inwardly disposed edges of the tape holding regions each have an entry chamfer 34. The extensions of the two connecting arms 28a and 28b form together with the continuous connecting region 30 and the two tape holding regions 32 the outer part 4 of the adhesive tape dispenser 1.

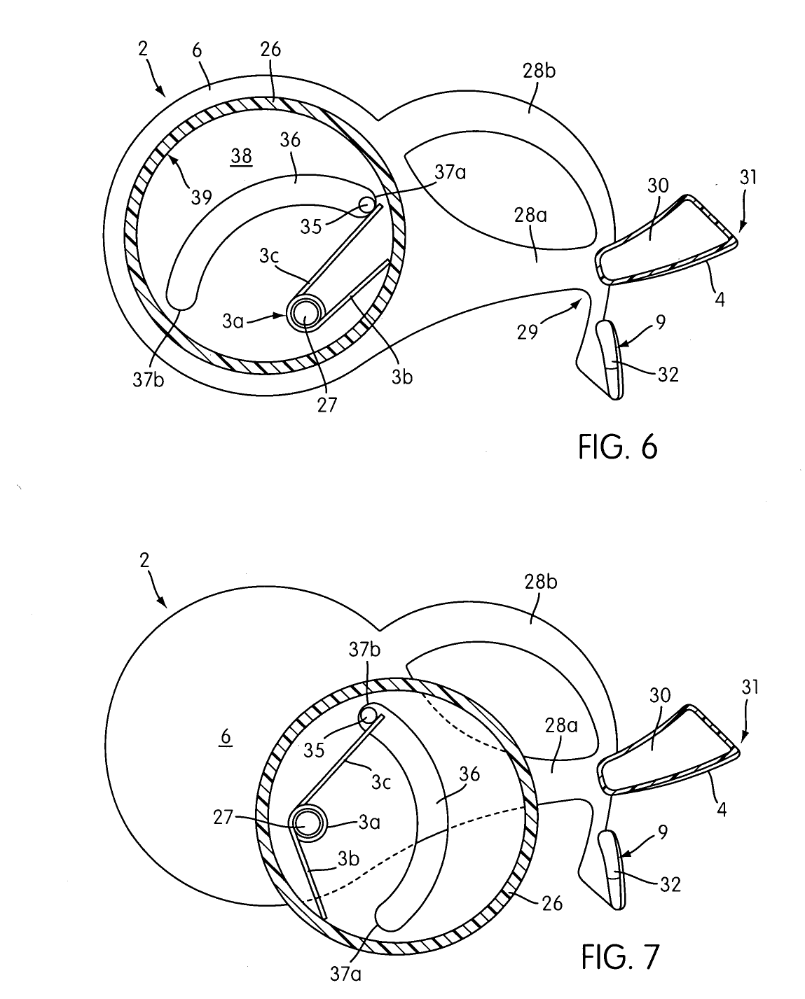

The pivot range of the bearing core 26 is limited in both directions by abutment means. The abutment means are here formed by a pin protruding, as projection 35, axially inwardly from a side wall 6 of the holder 2 and engaging in an arcuate opening 36 in the corresponding end face of the bearing core 26. In the case of the first end position, which is illustrated in FIG. 6 and in which the spacing between the outer part 4 and the bearing core 26 is at a maximum, the pin 35 bears against the first end 37a of the opening 36. In the case of the second end position, which is illustrated in FIG. 7, of the bearing core 26 the spacing between the outer part 4 and the bearing core 26 is reduced to a minimum. In that case the pin 35 bears against the second end 37b of the opening 36.

The bearing core 26 is constructed as a hollow cylinder. A leg spring 3a is arranged in its inner cavity 38 and urges the hollow cylinder, as resilient means, in the direction of the second end position, which is illustrated in FIG. 7 and in which the spacing between the outer part 4 and the bearing core 26 is at a minimum. The leg spring 3a is pivotably mounted by the central eye thereof on the pivot axle 27 of the bearing core 26, the axle being formed by two pins which each extend through a respective opening in the side wall of the bearing core 26 and which bear against one another within the cavity 38. The leg spring 3a is thus supported by one leg 3b against the inner wall 39 of the cavity 38 of the bearing core 26 and by the other leg 3c against the pin 35 belonging to the abutment means.

In this manner there is obtained an adhesive tape dispenser 1 according to the invention which is distinguished by a very compact and rigid mode of construction.

What is claimed is:

1. An Adhesive tape dispenser (1) with a holder (2) for reception of a coiled adhesive tape roll to be rotatable about an axis (5) and with an outer part (4) connected with the holder (2) and disposed radially outwardly of an inserted or insertable adhesive tape roll, the outer part (4) being suitable for fixing and/or detaching the free end of an inserted adhesive tape roll and being movably connected with the holder (2), wherein the adhesive tape dispenser (1) comprises at least one resilient means (3) by which the outer part (4) is loaded in a direction in which the spacing thereof from the axis (5) reduces, wherein the adhesive tape dispenser comprises two resilient means (3), wherein each resilient means (3) is effective at a respective one of the two end faces of the outer part (4) or an inserted adhesive tape roll and wherein the resilient means is formed by a bent spring arm (3) by way of which the holder (2) is connected with the outer part (4), the bend of the spring arm (3) being resiliently reducible.

2. An adhesive tape dispenser (1) with a holder (2) for reception of a wound adhesive tape coil (23) to be rotatable about an axis (5) and with an outer part (4) connected with the holder (2) and disposed in a region lying radially outwardly of an insertable adhesive tape roll (23), the outer part being suitable for fixing and/or detaching the free end (33) of an insertable adhesive tape roll (23), wherein the holder (2) comprises a bearing core (26) on which an adhesive tape roll (23) is receivable to be rotatable and the outer part (4) being movably connected with the bearing core (26) of the holder (2), wherein the adhesive tape dispenser (1) comprises at least one resilient means (3, 3a) by which the outer part (4) and/or the bearing core (26) is loaded in a direction in which the spacing between the outer part (4) and the bearing core (26) reduces, wherein the bearing core (26) is eccentrically pivotable about a pivot axis (27) and is mounted between the side walls (6) of the holder (2) to be loaded by the resilient means (3a) and wherein the bearing core (26) is formed by a hollow cylinder and the resilient means (3a) is arranged in the cavity (38) of the cylinder, the outer part (4) being fixedly connected with side walls (6) of the holder (2).

3. The adhesive tape dispenser of claim 1, wherein the outer part (4) can be brought by the resilient means (3, 3a) resiliently into contact with the outer circumferential surface of an inserted adhesive tape roll (23).

4. The adhesive tape dispenser of claim 2, wherein the outer part (4) can be brought by the resilient means (3, 3a) resiliently into contact with the outer circumferential surface of an inserted adhesive tape roll (23).

5. The adhesive tape dispenser of claim 1, wherein the resilient means (3) comprises a compression spring pressing the outer part (4) from outside against an adhesive tape roll.

6. The adhesive tape dispenser of claim 2, wherein the resilient means (3) comprises a compression spring pressing the outer part (4) from outside against an adhesive tape roll.

7. The adhesive tape dispenser of claim 1, wherein the spring arm (3) is bent substantially parabolically or in U-shape, one end region (12) of the spring arm (3) extending at least approximately tangentially from a region of the holder (2) disposed between the axis (5) and an inserted adhesive tape roll and the other end region (13) of the spring arm (3) terminating at least approximately tangentially on the diameter of the outer circumferential surface of an inserted adhesive tape roll.

8. The adhesive tape dispenser of claim 7, wherein a respective spring arm (3) is arranged on each of the two sides axially adjacent to an inserted adhesive tape roll, the two spring arms (3) being interconnected at the end regions (12, 13) thereof at one end by the holder (2) and at the other end by the outer part (4).

9. The adhesive tape dispenser of claim 8, wherein the two spring arms (3) are interconnected in an intermediate region by an additional connecting web (14) disposed radially outwardly of an inserted adhesive tape roll and arranged to preferably project outwardly, the intermediate region preferably being disposed between the outer part (4) and the centre of the spring arms (3).

10. The adhesive tape dispenser of claim 8, wherein the two spring arms (3) each have in the end region (13) thereof connected with the outer part (4) a respective inwardly projecting projection (18) placeable as guide means axially against the end face of an inserted adhesive tape roll.

11. The adhesive tape dispenser of claim 1, wherein the outer part (4) comprises a tape holding region with an outwardly facing roughened or grooved surface (9) to which the free end (33) of an adhesive tape roll (23) can be adhered to be easily detachable.

12. The adhesive tape dispenser of claim 2, wherein the outer part (4) comprises a tape holding region with an outwardly facing roughened or grooved surface (9) to which the free end (33) of an adhesive tape roll (23) can be adhered to be easily detachable.

13. The adhesive tape dispenser of claim 1, wherein the outer part (4) comprises a detaching device (10, 11, 31), particularly a pointed edge (10), a toothed strip (31) or a knife, for detaching a piece of tape withdrawn from the adhesive tape roll (23).

14. The adhesive tape dispenser of claim 2, wherein the outer part (4) comprises a detaching device (10, 11, 31), particularly a pointed edge (10), a toothed strip (31) or a knife, for detaching a piece of tape withdrawn from the adhesive tape roll (23).

15. The adhesive tape dispenser of claim 1, wherein the outer part (4) has a tear-off edge (11) radiussed about an axis extending parallel to the axis (5).

16. The adhesive tape dispenser of claim 2, wherein the outer part (4) has a tear-off edge (11) radiussed about an axis extending parallel to the axis (5).

17. The adhesive tape dispenser of claim 1, wherein the holder (2) has a grip recess (8) on at least one of its two outwardly disposed side walls (6).

18. The adhesive tape dispenser of claim 2, wherein the holder (2) has a grip recess (8) on at least one of its two outwardly disposed side walls (6).

19. The adhesive tape dispenser of claim 1, wherein it comprises means (19, 20) acting in mechanically positively locking and/or frictionally locking manner to prevent or hinder return rotational movement opposite to rotational movement in the direction (A) of unrolling an inserted or insertable adhesive tape roll (23).

20. The adhesive tape dispenser of claim 2, wherein it comprises means (19, 20) acting in mechanically positively locking and/or frictionally locking manner to prevent or hinder return rotational movement opposite to rotational movement in the direction (A) of unrolling an inserted or insertable adhesive tape roll (23).

21. The adhesive tape dispenser of claim 19, wherein the holder (2) comprises means (19, 20), particularly resilient means (19, 20), co-operating with the core reel (24) of an adhesive tape roll (23).

22. The adhesive tape dispenser of claim 21, wherein at least one spring tongue (20) aligned in the circumferential direction of a core reel (24) to be received, or a received core reel (24), of an adhesive tape roll (23) is arranged at the holder (2), the free end (22) of the at least one spring tongue (20) pointing in the desired direction (A) of unrolling of the adhesive tape roll (23) and resiliently protruding axially inwardly in order to resiliently engage in recesses provided at the end face of the core roll (24).

23. The adhesive tape dispenser of claim 8, wherein at least one spring arm (3) has in an axial and/or radially flexibly resilient region, which bears or can bear against a toothing of the core roll (24) of an inserted or insertable adhesive tape roll or directly against a toothed end face of an inserted or insertable adhesive tape roll, a projection, particularly a lug protruding in wedge shape, for engagement in the corresponding toothing.

24. The adhesive tape dispenser of claim 1, wherein it is made integrally of plastics material formed to be transparent.

25. The adhesive tape dispenser of claim 24, wherein the resilient means or spring arms (3) contain a permanently resilient plastics material, particularly polycarbonate.

26. The adhesive tape dispenser of claim 2, wherein the bearing core (26) is eccentrically pivotable about a pivot axis (27) and is mounted between the side walls (6) of the holder (2) to be loaded by the resilient means (3a).

27. The adhesive tape dispenser of claim 26, wherein the bearing core (26) is formed by a hollow cylinder, the resilient means (3a) being arranged in the cavity (38) of the cylinder.

28. The adhesive tape dispenser of claim 26, wherein the resilient means comprise a leg spring (3a) pivotably mounted on the pivot axle (27) of the bearing core (26) and supported by one leg (3a) at the inner wall (39) of the cavity (38) and by the other leg at the projection (35), the projection (35) protruding through the opening (36) into the cavity (38).

29. The adhesive tape dispenser of claim 1, wherein it is constructed as a disposable dispenser with an inserted adhesive tape roll (23), the side edges of the adhesive tape roll (23) being formed to be grooved, serrated or corrugated.

30. The adhesive tape dispenser of claim 1, wherein it is constructed as a repeat-use reusable dispenser into which an adhesive tape roll (23) is insertable.

31. The adhesive tape dispenser of claim 28, wherein the holder (2) comprises abutment means (35, 36) for limiting the pivot range of the bearing core (26).

32. The adhesive tape dispenser of claim 31, wherein the abutment means comprises at least one projection (35) projecting axially inwardly from a side wall (6) of the holder (2) and engaging in an arcuate recess or opening (36) in an end face of the bearing core (26).

33. The adhesive tape dispenser of claim 29, wherein the resilient means comprise a leg spring (3a) pivotably mounted on the pivot axle (27) of the bearing core (26) and supported by one leg (3a) at the inner wall (39) of the cavity (38) and by the other leg at the projection (35), the projection (35) protruding through the opening (36) into the cavity (38).

34. The adhesive tape dispenser of claim 1, wherein it is constructed as a disposable dispenser with an inserted adhesive tape roll (23), the side edges of the adhesive tape roll (23) being formed to be grooved, serrated or corrugated.

35. The adhesive tape dispenser of claim 1, wherein it is constructed as a repeat-use reusable dispenser into which an adhesive tape roll (23) is insertable.
